(19) United States
(12) Patent Application Publication
(10) Pub. No.: US 2012/0321377 A1
(43) Pub. Date: Dec. 20, 2012

(54) STRETCHABLE AND BENDABLE ASSEMBLY DEVICE

(76) Inventor: Hung-Wei FANG, New Taipei City (TW)

(21) Appl. No.: 13/160,329

(22) Filed: Jun. 14, 2011

(51) Int. Cl. F16B 17/00

(52) U.S. Cl. 403/291

(57) ABSTRACT

A stretchable and bendable assembly device includes a bending element and a positioning element, and the bending element includes a bending section and a latch portion formed at an end of the bending section, and the positioning element is elastically installed onto the latch portion and includes a containing portion for receiving the latch portion, and the containing portion has an exit formed on the positioning element, and the bending section is extended out from the exit. In addition, a wavy latch portion is formed in the containing portion of the positioning element and corresponding to the latch portion, and the wavy latch portion includes a plurality of section-positions, and each section-position can be latched to the corresponding latch portion.

### FIELD OF THE INVENTION

The present invention relates to an assembly device, in particular to a stretchable and bendable assembly device.

### BACKGROUND OF THE INVENTION

Conventional silicone cases or leather cases are generally used for the protection and aesthetic appearance purposes of a 3C product such as a PDA, a mobile phone or a tablet PC. The silicon cases or leather cases simply provides the protective function and provides the aesthetic appearance only. When a user needs to set the 3C product in an erect or tilted position for a convenient view or operation, the user usually needs to prepare and carry a placing stand or a fixing stand.

In view of the aforementioned drawback of the prior art, the inventor of the present invention based on years of experience in the related industry to conduct extensive researches and experiments, and finally provided a feasible design in accordance with the present invention to overcome the drawback of the prior art.

### SUMMARY OF THE INVENTION

Therefore, it is a primary objective of the present invention to provide a stretchable and bendable assembly device covered by a silicone case or a leather case as a support, such that the silicone case or the leather case can have appropriate bendability and support for tilting and erecting a 3C product.

To achieve the foregoing objective, the present invention provides a stretchable and bendable assembly device, comprising: a bending element and a positioning element, wherein the bending element includes a bending section and a latch portion formed at an end of the bending section, and the positioning element is elastically installed onto the latch portion and includes a containing portion for receiving the latch portion, and the containing portion has an exit formed on the positioning element, and the bending section is extended out from the exit.

### BRIEF DESCRIPTION OF THE DRAWINGS

FIG. 1 is an exploded view of a first preferred embodiment of the present invention;

FIG. 2 is a perspective view of a first preferred embodiment of the present invention;

FIG. 3 is a schematic view of an application of a first preferred embodiment of the present invention;

FIG. 4 is a first schematic view of an operation of a first preferred embodiment of the present invention;

FIG. 5 is a second schematic view of an operation of a first preferred embodiment of the present invention;

FIG. 6 is an exploded view of a second preferred embodiment of the present invention;

FIG. 7 is a perspective view of a second preferred embodiment of the present invention; and

FIG. 8 is an exploded view of a third preferred embodiment of the present invention.

### DESCRIPTION OF THE PREFERRED EMBODIMENTS

The technical characteristics and contents of the present invention will become apparent with the following detailed description and related drawings. The drawings are provided for the purpose of illustrating the present invention only, but not intended for limiting the scope of the invention.

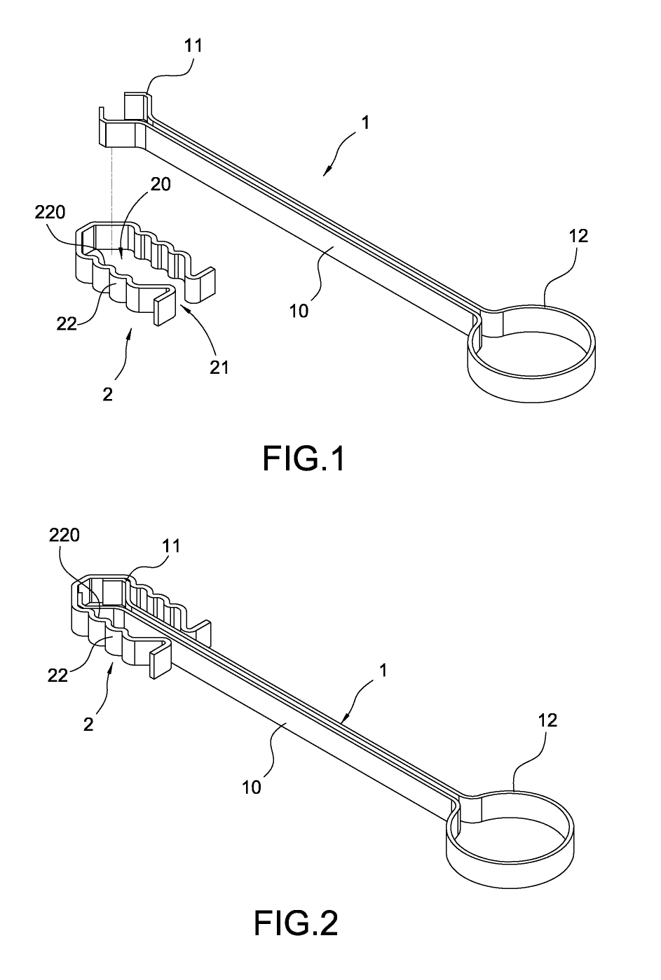

With reference to FIGS. 1 and 2 for an exploded view and a perspective view of a first preferred embodiment of the present invention respectively, the present invention provides a stretchable and bendable assembly device comprising a bending element 1 and a positioning element 2.

The bending element 1 is substantially in the shape of a long strip, and made of metal or plastic, and the bending element 1 includes a bending section 10, and the bending section 10 can be deformed and bent by an external force and the bending section 10 can resume its original shape and position after the external force is eliminated. In addition, a latch portion 11 is formed at an end of the bending section 10, and a fixing portion 12 is formed at another end of the bending section 10.

The positioning element 2 is substantially U-shaped and elastically installed onto the latch portion 11 of the bending element 1, and the positioning element 2 includes a hollow containing portion 20 for receiving the latch portion 11 of the bending element 1 from a side of the containing portion 20, and the containing portion 20 has an exit 32 formed on the positioning element 2 and provided for receiving the latch portion 11 into the containing portion 20, such that the bending section 10 of the bending element 1 can be extended out from the exit 21. In the meantime, a wavy latch portion 22 is formed in the containing portion 20 of the positioning element 2 and corresponding to the latch portion 11, and the wavy latch portion 22 includes a plurality of section-positions 220, and each section-position 220 can produce a latching effect with the latch portion 11, so that when the bending section 10 of the bending element 1 is pulled to a specific length towards the external side of the exit 21, each section-position 220 can provide a positioning effect.

With the aforementioned components, the stretchable and bendable assembly device of the present invention is achieved.

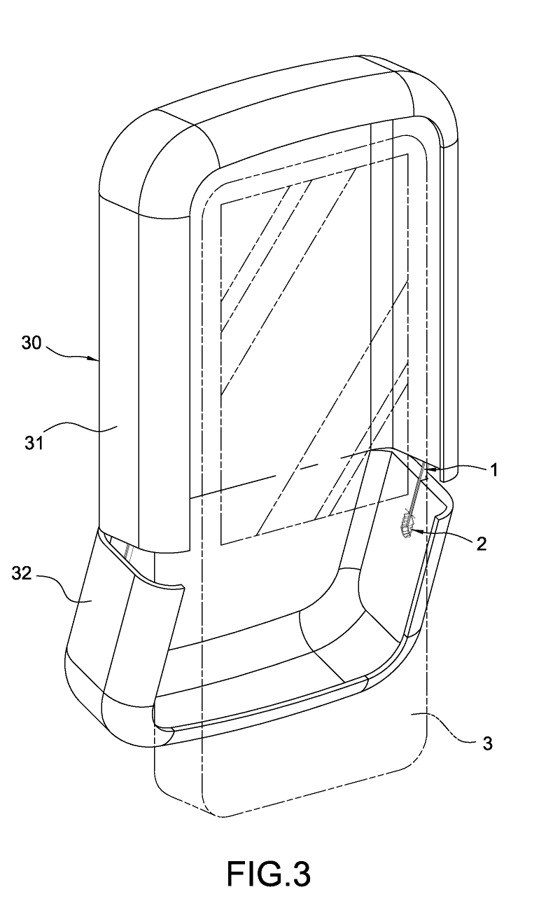

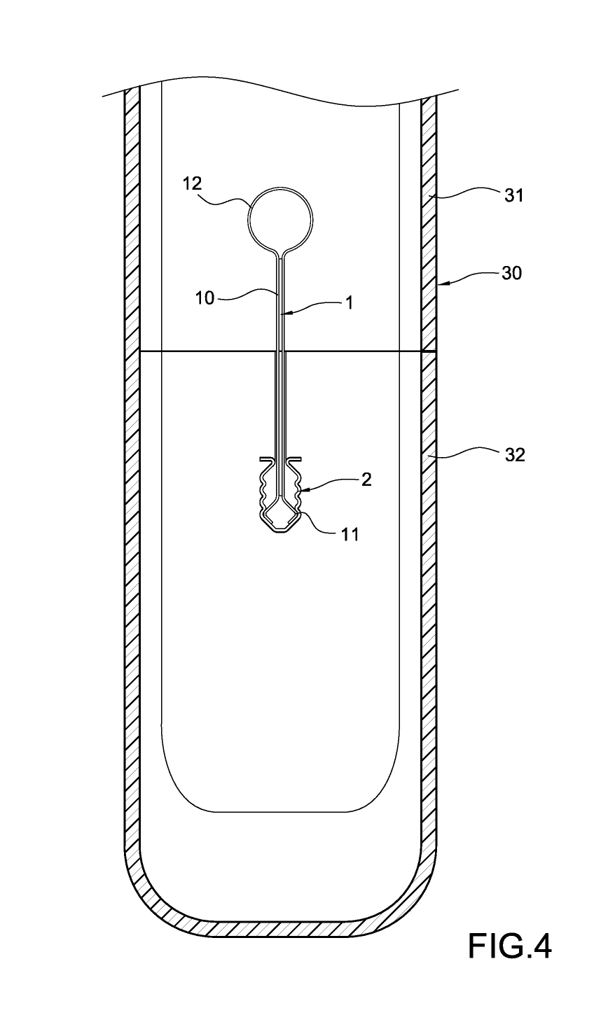

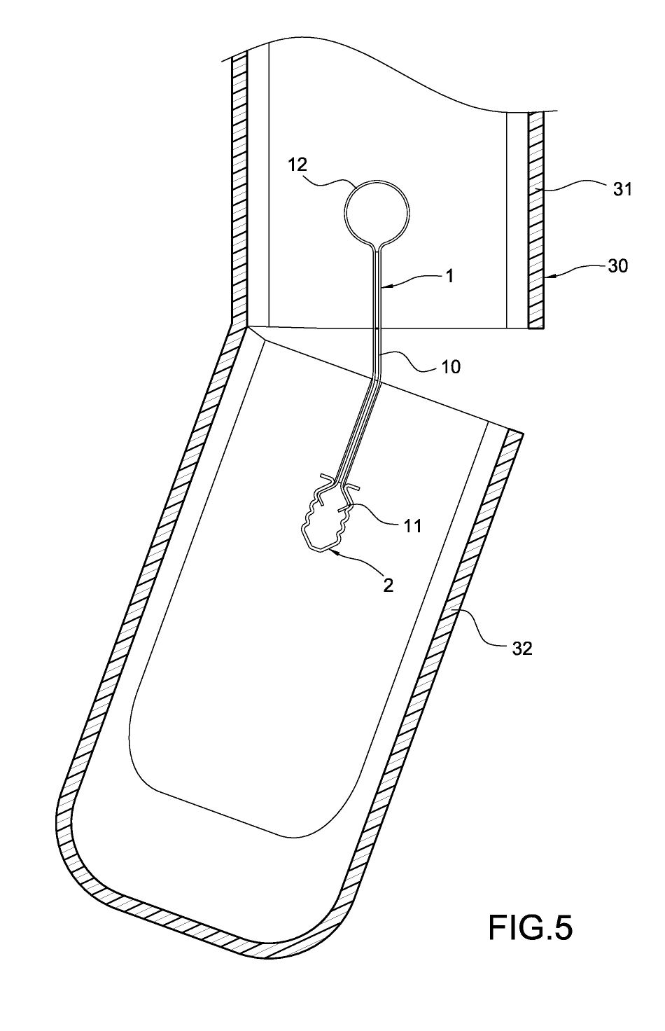

In FIG. 3, if the present invention is applied to a leather case 30 of a 3C product such as a mobile phone 3, the leather case 30 can be cut and divided into an upper-half portion 31 and a lower-half portion 32 which are not cut off completely from each other, and the stretchable and bendable assembly device of the present invention is installed at a cutting position between the upper-half portion 31 and the lower-half portion 32 for the connection. In FIGS. 4 and 5, the bending section 10 of the bending element 1 is extended onto the upper- and lower-half portions 31, 32 of the leather case 30, and fixed and coupled to the upper-half portion 31 through the fixing portion 12 of bending section 10, and fixed to the lower-half portion 32 of the positioning element 2, and vice versa. Now, if a user needs to erect the mobile phone 3 on a table or at a disposing position, the user simply needs to pull the lower-half portion 32 of the leather case out from the mobile phone 3, such that when an external force is applied to pull, stretch, and bend the bending section 10 of the bending element 1, the characteristic of the bending section 10 of the bending element 1 being deformed and bent by the external force is used for pulling and bending the bending section 10 as the lower-half portion 32 is pulled out. The deformation can be produced by pulling and stretching the bending section 10 while the latch portion 11 and the wavy latch portion 22 provide the positioning effect, such that the outwardly pulled lower-half portion 32 can be supported by the support force of the present invention, and the leather case 30 can be used as a support stand of the mobile phone 3 to facilitate the user to view or operate the mobile phone without requiring other accessories, so as to achieve a convenient carry effect.

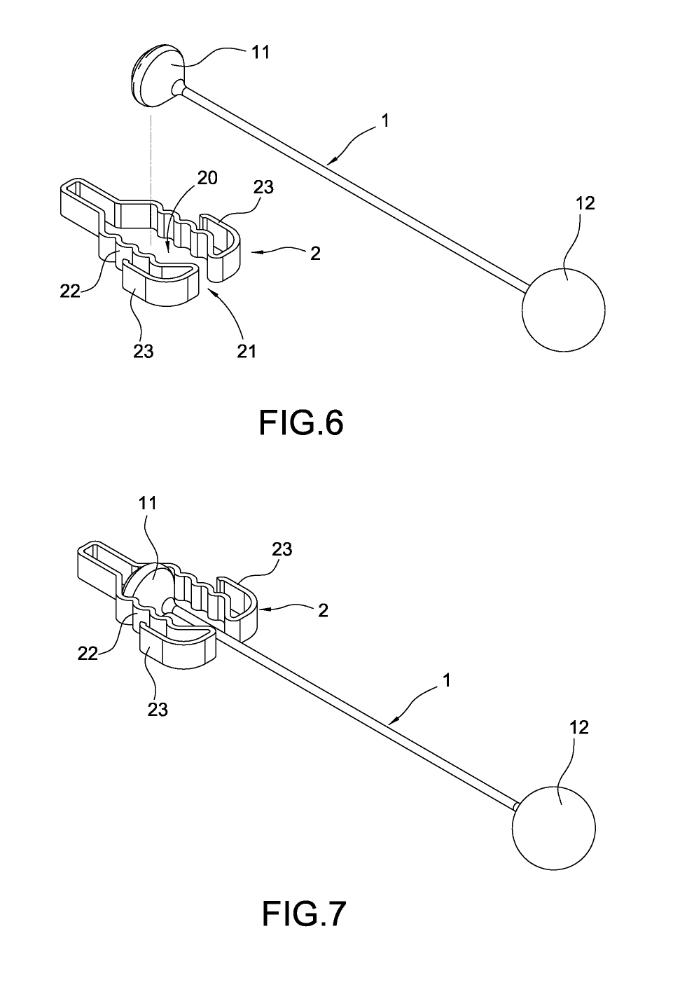

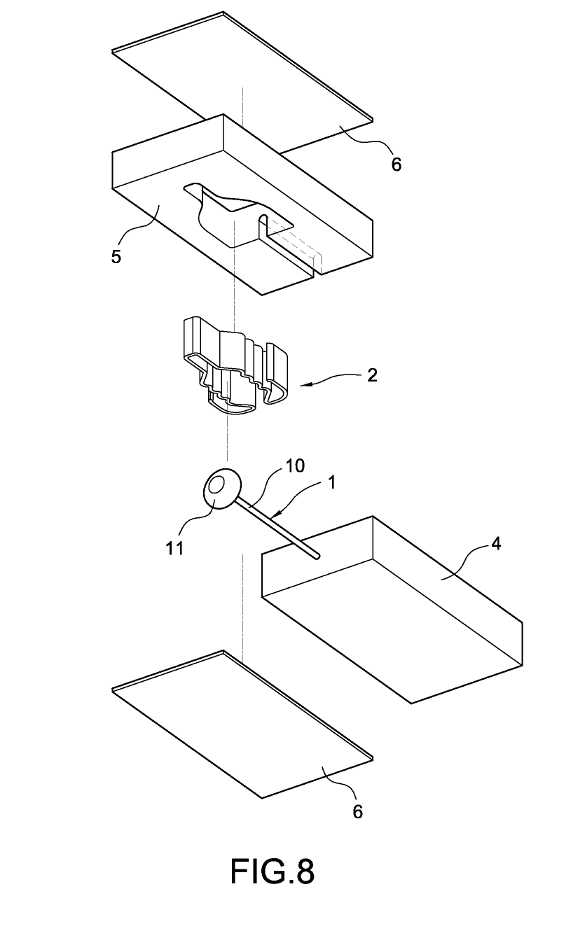

With reference to FIGS. 6 and 7 for an exploded view and a perspective view of a second preferred embodiment of the present invention respectively, the latch portion 11 of the bending element 1 can be a flat elliptical body, and the fixing portion 12 can be a spherical body. In addition, a protection portion 23 can be formed by pulling the positioning element 2 out from both sides of the exit 21 and extending to the external side of the wavy latch portion 22. With reference to FIG. 8 for an exploded view of a third preferred embodiment of the present invention, the invention further comprises a first panel 4 and a second panel 5, wherein the first panel 4 is fixed onto an end of the bending section 10 of the bending element 1, and the second panel 5 is provided for receiving the positioning element 2, and a cover 5 is covered separately onto both sides of the second panel 5 for the protection purpose.

In summation of the description above, the present invention improves over the prior art and complies with the patent application requirements, and thus is duly filed for patent application.

While the invention has been described by means of specific embodiments, numerous modifications and variations could be made thereto by those skilled in the art without departing from the scope and spirit of the invention set forth in the claims.

What is claimed is:

1. A stretchable and bendable assembly device, comprising:
a bending element, having a bending section, and a latch portion formed at an end of the bending section; and
a positioning element, elastically installed onto the latch portion, and having a containing portion for receiving the latch portion, and the containing portion having an exit formed on the positioning element, and the bending section extending out from the exit.

2. The stretchable and bendable assembly device of claim 1, further comprising a fixing portion formed at another end of the bending section of the bending element.

3. The stretchable and bendable assembly device of claim 2, wherein the fixing portion is a spherical body.

4. The stretchable and bendable assembly device of claim 1, wherein the latch portion of the bending element is a flat elliptical body.

5. The stretchable and bendable assembly device of claim 1, wherein the positioning element is substantially U-shaped.

6. The stretchable and bendable assembly device of claim 1, wherein the containing portion of the positioning element includes a wavy latch portion formed therein and corresponding to the latch portion, and the wavy latch portion has a plurality of section-positions thereon, and each section-position is latchable to the latch portion.

7. The stretchable and bendable assembly device of claim 1, wherein the positioning element includes a protection portion formed by folding both sides of the exit outward and extending to the external side of the wavy latch portion.

8. The stretchable and bendable assembly device of claim 1, further comprising a first panel and a second panel, and the first panel is fixed onto an end of the bending section of the bending element, and the second panel is provided for containing the positioning element.

9. The stretchable and bendable assembly device of claim 8, wherein both sides of the second panel are covered separately by a cover.
